(19) United States
(12) Patent Application Publication
(10) Pub. No.: US 2024/0185001 A1
(43) Pub. Date: Jun. 6, 2024

(54) DATASET GENERATION USING LARGE LANGUAGE MODELS

(71) Applicant: NVIDIA Corporation, Santa Clara, CA (US)

(72) Inventors: Divija Nagaraju, Mountain View, CA (US); Christopher Parisien, Toronto (CA)

(21) Appl. No.: 18/075,942

(22) Filed: Dec. 6, 2022

(51) Int. Cl. G06F 40/56; G06F 40/284

(52) U.S. Cl. CPC G06F 40/56; G06F 40/284

(57) ABSTRACT

Disclosed are systems and techniques that may generate datasets for training task-oriented dialogue systems. The techniques include generating natural language queries by selecting a template query, sampling one or more tokens from a data store of domain-specific tokens, modifying the selected template query using the one or more sampled tokens to generate a query prompt, and using a natural language generative machine-learning model to generate, based on the query prompt, a respective natural language query of the subset of the plurality of natural language queries, and causing the generated plurality of natural language queries to be provided to a machine-learning model training engine configured to train, using the generated plurality of natural language queries, a conversational machine-learning model to perform a domain-specific conversational task.

### TECHNICAL FIELD

At least one embodiment pertains to processing resources and techniques that facilitate artificial intelligence. For example, at least one embodiment pertains to efficient generation of datasets used to train conversational machine-learning models.

### BACKGROUND

Artificial intelligence is consistently being used to automate new and more complex tasks that were previously performed by humans. In addition to designing efficient and effective machine-learning model (MLM) architectures, the successful deployment or application of the MLMs also depends heavily on the training techniques employed. For example, training an MLM to perform a specific task often requires large amounts of training data, and the data needs to be relevant or tuned to the specific task of the MLM. For example, training a natural language processing MLM specialized in a particular conversational domain (e.g., retail sales dialogues) typically involves many examples of relevant conversations in the retail sales space.

### BRIEF DESCRIPTION OF DRAWINGS

FIG. 1 is a block diagram of an example computer system that uses task-specific data, template queries, and a trained large language model for generating training data, according to at least one embodiment;

FIG. 2 illustrates an example computing device which may generate training data and train a conversational machine-learning model, according to at least one embodiment;

FIG. 3 illustrates an example data flow during generation of training data and training of a conversational machine-learning model, according to at least one embodiment;

FIG. 4A illustrates an example template query, according to at least one embodiment;

FIG. 4B illustrates an example data flow combining task data and a template query to generate a prompt which is used by a trained large language model to generate a natural-language query, according to at least one embodiment;

FIG. 5 is a flow diagram of an example method of using task-specific data, template queries, and a trained large language model for generating training data, according to at least one embodiment;

FIG. 6 is a flow diagram of an example method of generating a template query using a machine-learning model with learned virtual tokens, according to at least one embodiment;

FIG. 7A illustrates inference and/or training logic, according to at least one embodiment of the present disclosure;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment; and

FIG. 10 is a system diagram for an example system for training, adapting, instantiating and deploying machine learning models in an advanced computing pipeline, according to at least one embodiment.

### DETAILED DESCRIPTION

Obtaining a sufficient amount of data to adequately train machine-learning models (MLMs) may be accomplished through crowdsourcing efforts, purchasing data from a vendor, collecting data through preexisting infrastructure, and/or generating synthetic data, all of which can be expensive and/or time consuming. Sometimes the task to be performed requires access to private or sensitive data, which makes obtaining and/or using such data more difficult—e.g., the data may need to be reviewed and edited to remove private or sensitive information. In addition, some existing methods of data collection or generation result in a limited variety of data such that, even if a developer has acquired a large amount of data, the data may not have much variety. When using data of limited variety, the MLMs trained on this data may not be very robust or versatile. Such difficulties related to collecting or generating large quantities of varied data can make training and deploying MLMs infeasible for development teams with limited budgets or short timelines.

As a non-limiting example, trained MLMs can be used for task-oriented dialogue systems (e.g., chatbots, digital avatars, etc.). These models, once trained, may respond to user prompts that are similar to the prompts that were seen by the model during training. As a result, to create a robust MLM that responds well to a variety of user interactions, it is important to train the MLM using data that realistically approximates the variety of interactions that are to be supported by the MLM. Thus, the training data should be sufficiently varied to train the MLM to respond to a variety of prompts, and should also be tailored specifically to the domain(s) in which the MLM will be used (e.g., restaurant ordering, hotel reservations, financial transactions, and/or the like). Sometimes, when such data is not readily available and cannot feasibly be collected through other means, generative grammars or template forms are used to create synthetic training data. However, this often leads to a lack of linguistic diversity due to the restrictive nature of templates and to accidental inclusion of ungrammatical or implausible examples—e.g., by forcing information into template slot locations that result in unnatural or improper language.

Aspects and embodiments of the present disclosure address these and other technological challenges by using a combination of structured data, domain-specific prompts, and large language models (LLMs) (e.g., large generative language models) to generate robust and varied datasets that can be used to effectively train MLMs for, without limitation, task-oriented dialogue systems. By using specifically engineered prompts and structured data that corresponds to the task that the MLM is being trained to perform, the disclosed embodiments can create synthetic datasets that simulate the varied interactions that the trained MLM is likely to encounter in deployment.

In some embodiments, the disclosed techniques may include obtaining a set of structured data—which may refer to data organized according to a particular format or data model, and may include task-specific terms. For example, if the synthetic dataset to be generated is for an MLM that will be used to facilitate restaurant ordering interactions, the structured data may include menu items available at the restaurant (e.g., hot dog, hamburger, fries, soda, etc.). The disclosed techniques may then combine a template query with a sampling of the structured data, where the template query may include one or more examples of input/output pairings that a LLM may be trained to replicate. For example, the template query may include a domain-specific example query and a natural language (NL) response to the example query. The template query may also include placeholders that may be replaced by the sampled structured data. By using the same template query with different samplings of the structured data, many different query prompts can be created.

The prompt may then be passed to a LLM, and the LLM may then generate a conversational (e.g., natural language) query in response to the prompt that can be included in the generated dataset. In some embodiments, the template query may include a condition or a condition template that targets the output of the LLM to a sub-task of the overall task to be performed. The condition may include a placeholder for a single task-specific datum from the sampled structured data. The single task-specific datum may be stored with the output generated by the LLM in the generated dataset and may be used as a target result for the generated output. The target result may represent the desired output or action of the dialogue system, which may include a target output of a natural language understanding (NLU) system (e.g., intents, slots, or another semantic representation), the desired action of the dialogue system (e.g., whether to call a backend system application programmer interface (API)), and/or the desired natural language response to the user.

In some embodiments, the template query may be selected randomly from a collection of template queries. In embodiments, the template query may be selected from a collection of template queries using weighted sampling. To increase the diversity of the generated outputs, the template queries may include examples of outputs that use colloquial phrasing or descriptions of task-specific items instead of naming the task-specific item directly. Some template queries may include outputs that do not correspond to any task-specific item, and/or some template queries may include examples of long or complex outputs or outputs that include terms modifying task-specific items. Because the LLM has been trained on such a large amount of data, the LLM may be able to appropriately respond to the varied template queries and generate a more varied set of conversational query outputs. As a result, the dialogue system trained using the conversational query outputs will be able to appropriately respond to a large variety of user interactions.

In one or more embodiments, the outputs generated using the LLM may be classified and labelled as realistic outputs or unrealistic outputs. Using these labelled outputs, the template queries may be tuned so that more realistic outputs than unrealistic outputs are generated by the LLM. For example, virtual tokens may be included in the template queries before being passed to a token-learning machine-learning model, and the model may then learn a set of tokens that result in the best outputs. These tokens may then be included in the template queries that are combined with the structured task-specific data to create prompts for the LLM.

The advantages of the disclosed techniques include but are not limited to systems and methods that are capable of generating a large amount of task-specific training data without the time and expense required by traditional data collection methods. By using specially curated template queries and task-specific structured data, the disclosed techniques can also create training data that includes more linguistic diversity and less ungrammatical or implausible examples than other dataset generation methods.

### System Architecture

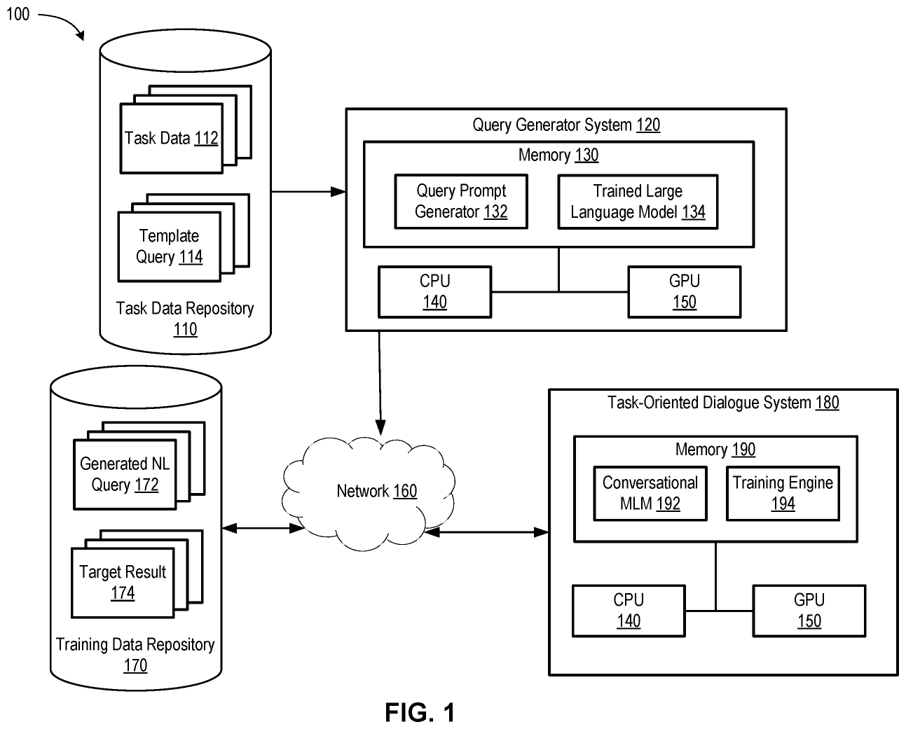

FIG. 1 is a block diagram of an example computer system 100 that uses task-specific data, template queries, and a trained large language model for generating training data, according to at least one embodiment. As depicted in FIG. 1, a computer system 100 may include a task data repository 110, a query generator system 120, a training data repository 170, and a task-oriented dialogue system 180 connected to a network(s) 160. Network(s) 160 may be a public network (e.g., the Internet), a private network (e.g., a local area network (LAN), or wide area network (WAN)), a wireless network, a personal area network (PAN), another network type, and/or a combination thereof.

Query generator system 120 include a desktop computer, a laptop computer, a smartphone, a tablet computer, a server, a wearable device, a virtual reality (VR)/augmented reality (AR)/mixed reality (MR) headset or heads up display, a digital avatar or chat bot kiosk, an in-vehicle infotainment computing device, and/or any suitable computing device capable of performing the techniques described herein. Query generator system 120 may be configured to receive task data 112 and template query 114. Task data 112 and template query 114 may be related to the task(s) to be performed using the task-oriented dialogue system. For example, if the task-oriented dialogue system is to be used to facilitate ordering items from a restaurant, task data 112 may include one or more menu items available to order at the restaurant. Similarly, template query 114 may include examples of a menu with items and a natural language (NL) query requesting one or more items from the menu. Task data 112 and template query 114 may be retrieved from task data repository 110 connected to query generator system 120, retrieved from memory 130 of query generator system 120, and/or received over any local or network connection (e.g., via network 160) from an external computing device. Task data 112 and template query 114 may be in any suitable format, e.g., plain text, XML, CSV, JSON, YAML, or any other compressed or uncompressed format. In some embodiments, task data 112 and/or template query 114 may be stored in a data store (e.g., a relational database, an object-oriented database, a key-value store, etc.).

Task data repository 110 may include a persistent storage capable of storing task-specific data, templates, and/or metadata corresponding to the stored data and templates. Task data repository 110 may be hosted by one or more storage devices, such as main memory, magnetic or optical storage disks, tapes, or hard drives, network-attached storage (NAS), storage area network (SAN), and so forth. Although depicted as separate from query generator system 120, in at least some embodiments, task data repository 110 may be a part of query generator system 120. In at least some embodiments, task data repository 110 may be a network-attached file server, while in other embodiments task data repository 110 may be some other type of persistent storage such as an object-oriented database, a relational database, and so forth, that may be hosted by a server machine or one or more different machines coupled to the query generator system 120 via network 160.

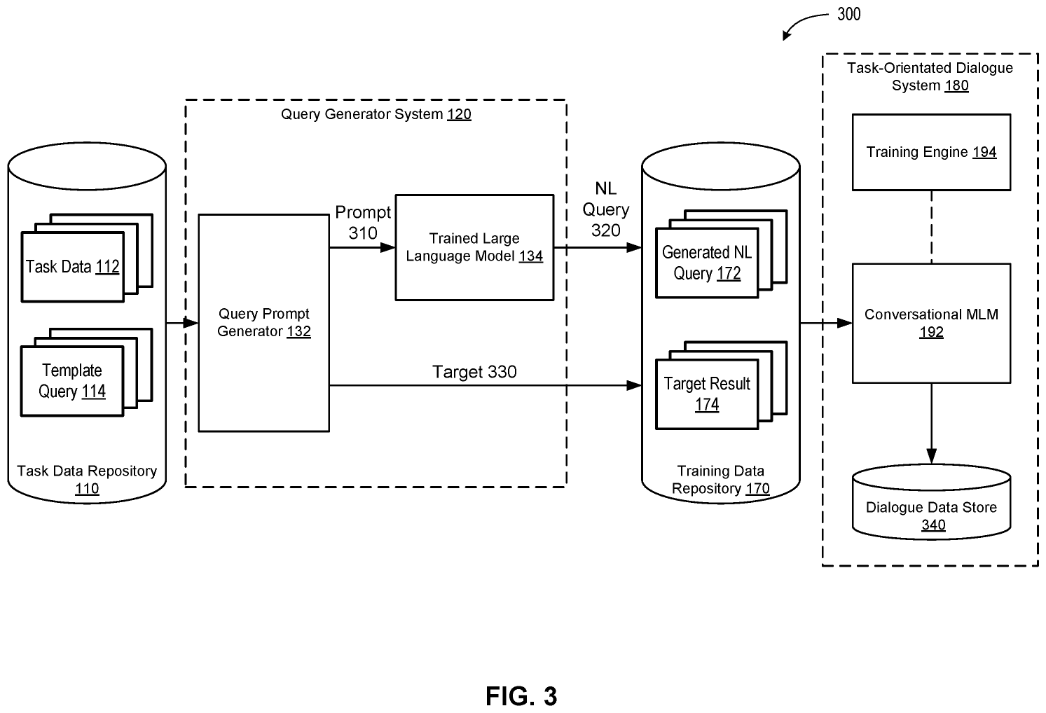

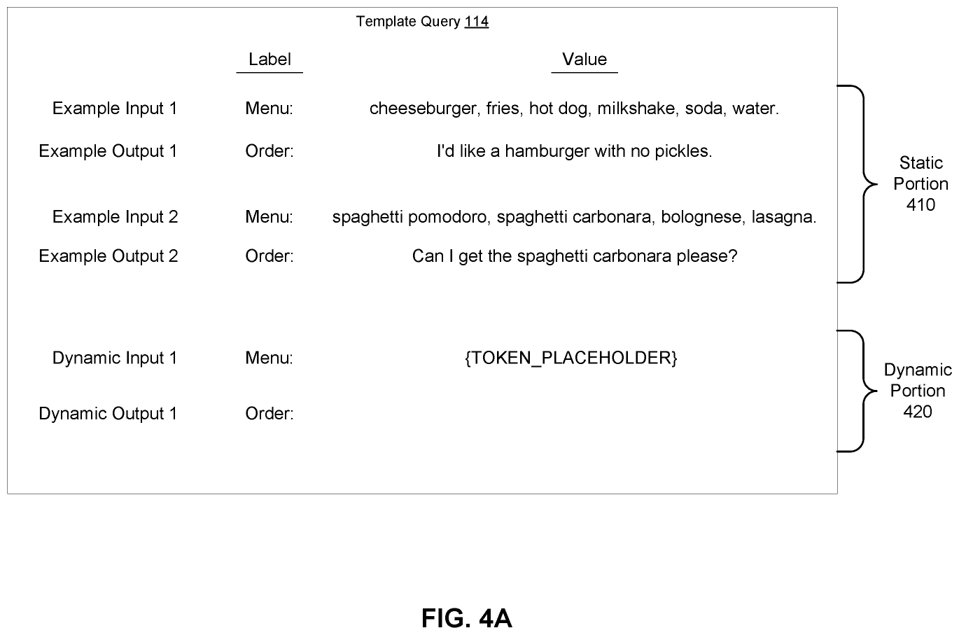

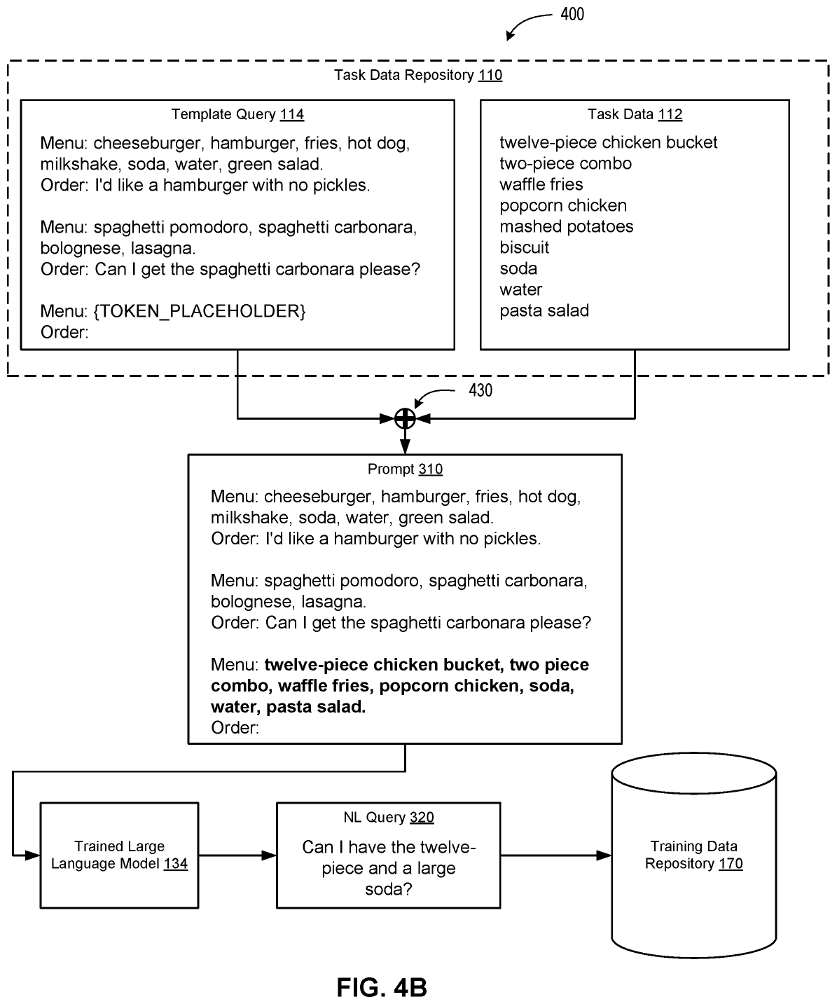

Query generator system 120 may include a memory 130 (e.g., one or more memory devices or units) communicatively coupled with one or more processing devices, such as one or more graphics processing units (GPU) 150 and/or one or more central processing units (CPU) 140. Memory 130 may store one or more codes, such as a query prompt generator 132 and a trained large language model 134. Any or all of query prompt generator 132 and/or trained large language model 134 may be executed using GPU 150 and/or CPU 140. In some embodiments, query prompt generator 132 may use task data 112 and template query 114 as an input. Task data 112 and template query 114 may be combined using query prompt generator 132 to generate a query prompt. Trained large language model 134 may process the generated query prompt to create a generated NL query 172. Trained large language model 134 may be any trained machine-learning model capable of performing text completion based on a provided example (e.g., GPT-3, BERT, ROBERTa, Megatron). In some embodiments, query prompt generator 132 may also generate a target result 174. Generated NL query 172 and/or target result 174 may be stored in training data repository 170, stored in memory 130 of query generator system 120, and/or transmitted over any local or network connection (e.g., via network 160) for storage in an external computing device. In some embodiments, training data repository 170 may be connected directly to query generator system 120. In other embodiments, training data repository 170 may be connected to query generator system 120 over a network connection (e.g., via network(s) 160) as shown in FIG. 1. Generated NL query 172 and target result 174 may be stored in any suitable format, e.g., plain text, XML, CSV, JSON, YAML, or any other compressed or uncompressed format. In some embodiments, generated NL query 172 and target result 174 may be stored in a data store (e.g., a relational database, an object-oriented database, a key value store, etc.). Further details about generating NL query 172 and/or target result 174 from task data 112 and template query 114 are disclosed herein at least with respect to FIGS. 3-4.

Training data repository 170 may include a persistent storage capable of storing generated NL queries and target results as well as metadata for the stored queries and target results. Training data repository 170 may be hosted by one or more storage devices, such as main memory, magnetic or optical storage disks, tapes, or hard drives, network-attached storage (NAS), storage area network (SAN), and so forth. Although depicted as separate from query generator system 120, in at least some embodiments, training data repository 170 may be a part of query generator system 120. In at least some embodiments, training data repository 170 may be a network-attached file server, while in other embodiments training data repository 170 may be some other type of persistent storage such as an object-oriented database, a relational database, and so forth, that may be hosted by a server machine or one or more different machines coupled to the query generator system 120 via network 160.

Task-oriented dialogue system 180 may include a memory 190 communicatively coupled with one or more processing devices, such as one or more GPUs 150 and one or more CPUs 140. Memory 190 may store one or more codes, such as conversational machine-learning model (MLM) 192 and/or training engine 194. Any or all of conversational MLM 192 and/or training engine 194 may be executed using GPU(s) 150, CPU(s) 140, and/or another processing unit type (e.g., an accelerator, such as a deep learning accelerator (DLA)). In some embodiments, training engine 194 may use generated NL query 172 to train conversational MLM 192. In other embodiments, training engine 194 may use generated NL query 172 and target result 174 to train conversational MLM 192. Task-oriented dialogue system 180 may retrieve generated NL query 172 and/or target result 174 from training data repository 170, which may be directly connected to task-oriented dialogue system 180 or may be connected to task-oriented dialogue system 180 over a network connection (e.g., via network(s) 160), as shown in FIG. 1.

In at least one embodiment, trained large language model 134 and/or conversational MLM 192 may be implemented as deep learning neural networks having multiple levels of linear or non-linear operations. For example, trained large language model 134 and/or conversational MLM 192 may include convolutional neural layers, recurrent neural layers, fully connected neural networks, neural networks with memory layers/subnetworks, and/or so on. In at least one embodiment, trained large language model 134 and/or conversational MLM 192 may include multiple neurons, where one or more individual neurons may receive its input from one or more other neurons and/or from an external source, and may produce an output by applying an activation function to the sum of weighted inputs and a bias value. In at least one embodiment, trained large language model 134 and/or conversational MLM 192 may include multiple neurons arranged in layers, including an input layer, one or more hidden layers, and/or an output layer. In embodiments, neurons from adjacent layers may be connected by weighted edges.

Generated NL query 172 may be used by training engine 194 to identify parameters (e.g., neural weights, biases, parameters of activation functions, etc.) of conversational MLM 192 that maximize success of task-oriented dialogue system 180. In some embodiments, training of conversational MLM 192 may be supervised, e.g., using human-annotations of generated NL query 172 as ground truth or using target result 174 as ground truth. In other embodiments, training of conversational MLM 192 may be unsupervised. In at least one embodiment, query generator system 120 and task-oriented dialogue system 180 may be implemented on a single computing device. Query generator system 120 and/or task-oriented dialogue system 180 may be (and/or include) a rackmount server, a router computer, a personal computer, a laptop computer, a tablet computer, a desktop computer, a media center, another device type, or any combination thereof.

Initially, parameters (e.g., edge weights and biases) of conversational MLM 192 may be assigned some starting (e.g., random) values. For every training input (e.g., generated NL query 172), training engine 194 may cause conversational MLM 192 to generate training output(s). Training engine 194 may then compare observed output(s) with the desired target output(s). The desired target output(s) may include target result 174 and/or human-annotated ground truths corresponding to the input (e.g., generated NL query 172). The resulting error or mismatch, e.g., the difference between the desired target output(s) and the actual output(s) of conversational MLM 192, may be back-propagated through conversational MLM 192, and the weights and biases in the conversational MLM 192 may be adjusted to make the actual or predicted output(s) closer to the target (ground truth) output(s). This adjustment may be repeated until the output error for a given training input satisfies a predetermined condition (e.g., falls below a predetermined value). Subsequently, a different training input may be selected, a new output generated, and a new series of adjustments implemented, until conversational MLM 192 is trained to (e.g., converges to) a target degree of accuracy. Although training of conversational MLM 192 is described in the aforementioned example, similar operations may be performed in training of other MLMs (e.g., large language model 134).

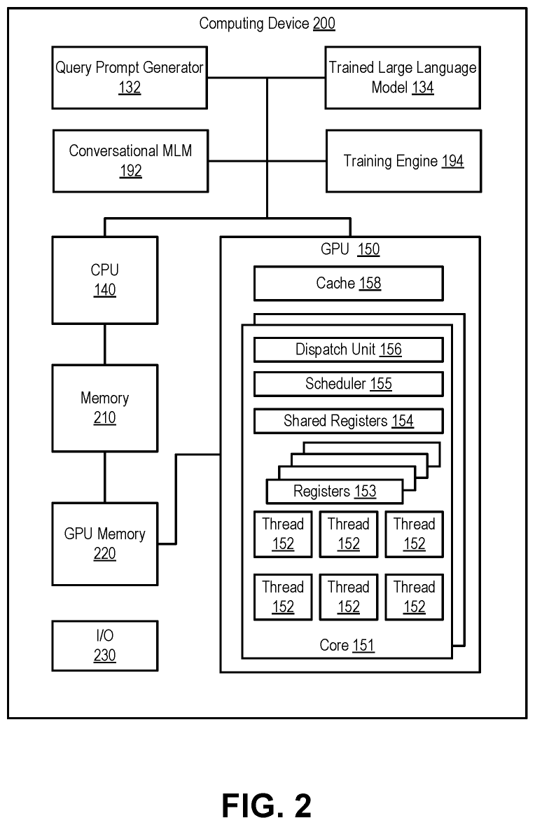

FIG. 2 illustrates an example computing device 200 which may generate training data and train a conversational machine-learning model, according to at least one embodiment. In at least one embodiment, computing device 200 may be a part of query generator system 120. In at least one embodiment, computing device 200 may be a part of task-oriented dialogue system 180. In at least one embodiment, query prompt generator 132, trained large language model 134, conversational MLM 192, and/or training engine 194 may be executed using one or more GPUs 150 (and/or other parallel processing units (PPUs) or accelerators, such as a deep learning accelerator, a data processing unit (DPU), etc.) and/or one or more CPUs 140. In at least one embodiment, a GPU 150 includes multiple cores 151, each core being capable of executing multiple threads 152. Each core may run multiple threads 152 concurrently (e.g., in parallel). In at least one embodiment, threads 152 may have access to registers 153. Registers 153 may be thread-specific registers with access to a register restricted to a respective thread. Additionally, shared registers 154 may be accessed by one or more (including all) threads of the core 151. In at least one embodiment, individual cores 151 may include a scheduler 155 to distribute computational tasks and processes among different threads 152 of core 151. A dispatch unit 156 may implement scheduled tasks on appropriate threads using correct private registers 153 and shared registers 154. Computing device 200 may include input/output component(s) 230 to facilitate exchange of information with one or more users or developers.

In at least one embodiment, GPU 150 may have a (high-speed) cache 158, access to which may be shared by multiple cores 151. Furthermore, computing device 200 may include a GPU memory 220 where GPU 150 may store intermediate and/or final results (outputs) of various computations performed using GPU 150. After completion of a particular task, GPU 150 (or CPU 140) may move the output to (main) memory 210. In at least one embodiment, CPU 140 may execute processes that involve serial computational tasks whereas GPU 150 may execute tasks (such as multiplication of inputs of a neural node by weights and adding biases) that are amenable to parallel processing. In at least one embodiment, specific codes (e.g., query prompt generator 132, trained large language model 134, conversational MLM 192, training engine 194) may determine which processes are to be executed on GPU 150 and which processes are to be executed on CPU 140. In other embodiments, CPU 140 may determine which processes are to be executed on GPU 150 and which processes are to be executed on CPU 140.

### Dataset Generation for Task-Oriented Dialogue Systems

FIG. 3 illustrates an example data flow 300 during generation of training data and training of a conversational machine-learning model, according to at least one embodiment. In at least one embodiment, the dataset generation system of FIG. 3 may be implemented using query generator system 120 and/or task-oriented dialogue system 180, which may be located on a single computing device or on different computing devices. Various blocks in FIG. 3 denoted with the same numerals as the respective blocks of FIG. 1 and/or FIG. 2 may implement the same (or a similar) functionality.

As illustrated in FIG. 3, query prompt generator 132 may receive task data 112 and template query 114 as input into query generator system 120. Query prompt generator 132 may combine task data 112 and template query 114 to create prompt 310. Prompt 310 may then be provided to trained large language model 134 to generate an output value (e.g., NL query 320). In some embodiments, query prompt generator 132 may also generate target 330. NL query 320 and/or target 330 may then be stored in training data repository 170. Training engine 194 may then use generated NL query 172 (e.g., NL query 320) and target result 174 (e.g., target 330) to train parameters of conversational MLM 192 as described herein. Output generated using conversational MLM 192 (e.g., one or more question-answer pairs) may be stored in a dialogue data store 340.

Task data 112 may include one or more task-specific or domain-specific tokens. Tokens may be any words, phrases, abbreviations, sentences, exclamations, and/or the like, that are encountered in conversations, advertisements, and/or printing materials pertaining to relevant tasks/domains. For example, if training data is being generated to train a task-oriented dialogue system that may be used in a restaurant environment, task data 112 may include menu items that are available for purchase. If the task-oriented dialogue system may be used in a hotel environment, task data 112 may include room configuration options (e.g., number of beds, bed sizes, smoking/non-smoking room, and/or so on). In a theater environment, task data 112 may include various ticket, location, theater, seating, and/or food options. In some embodiments, task data 112 may include frequently asked questions (FAQs) or may include data from an existing knowledge base (e.g., a company's internal resource center). In other embodiments, task data 112 may include data from more than one domain.

FIG. 4A illustrates an example template query 114, according to at least one embodiment. Template query 114 may include a static portion 410 and a dynamic portion 420. Static portion 410 of template query 114 may include example input/output pairings that trained large language model 134 is to simulate (e.g., using few-shot learning). Individual inputs and outputs of a pair may include a label (e.g., input label, output label) and a value (e.g., input value, output value). In some embodiments, some input/output labels may be the same for multiple example input/output pairings, while the input/output values for those pairings may be different. For example, template query 114 for training a conversational navigation model may include multiple input/output labels that are the same, e.g., “Input label: Destinations” and “Output label: Directions requests,” while the input/output values are different. For example, input values may include different lists of prominent city landmarks, e.g.,
Input value: Convention Center, City Hall, Baseball Stadium.
Output value: How do I get to the Convention Center?
Input value: University, Concert Hall, Fine Arts Museum.
Output value: Where is the Concert Hall?
   In some embodiments, the input/output labels and the input value for multiple example input/output pairings may be the same while the output values for these input/output pairings may be different. For example,
Input value: Convention Center, City Hall, Baseball Stadium.
Output value: How far is the City Hall?
Input value: Convention Center, City Hall, Baseball Stadium.
Output value: What is the fastest way to the Baseball Stadium?

Dynamic portion 420 of template query 114 may include a dynamic input/output pairing, with each input and output including a label and a value. In some embodiments, dynamic portion 420 may include a dynamic input/output pairing with the same input label and output label as the example input/output pairings in static portion 410 of template query 114. The input value of the dynamic input/output pairing of dynamic portion 420 of template query 114 may include placeholder tokens. The placeholder tokens may be replaced by one or more task-specific or domain-specific tokens from task data 112. The output value of the dynamic input/output pairing of dynamic portion 420 of template query 114 may be left empty for trained large language model 134 to generate according to the examples provided in static portion 410 of template query 114. By replacing the placeholder tokens in dynamic portion 420 of template query 114 with one or more task-specific or domain-specific tokens from task data 112, query prompt generator may generate prompt 310.

As another example, illustrated with FIG. 4A, query generator system 120 may generate training data to be used by task-oriented dialogue system 180 in a restaurant ordering environment. Static portion 410 of template query 114 may contain two example input/output pairings (e.g., example input/output 1 and example input/output 2). In some embodiments, the example pairings may be an example conversation between a customer and a service provider. The example pairing may come from a financial services domain, a food services domain, a health services domain, a retail services domain, and/or the like. Dynamic portion 420 of template query 114 may contain one dynamic input/output pairing (e.g., dynamic input/output 1). Example input 1 and example input 2 may both have “Menu:” as an input label. Example output 1 and example output 2 may both have “Order:” as an output label. Example input 1 and example input 2 may both have an input value that may include a list of menu items. Example output 1 and example output 2 may both have an output value that may include a NL query (e.g., a NL response) ordering one or more of the listed menu items from the respective input value. In some embodiments, the input values (e.g., menu items) may be the same in one or more of the example pairings. The dynamic input/output pairing may also have “Menu:” as an input label and “Order:” as the output label. The input value of the dynamic pairing may have placeholder tokens. The placeholder tokens may be replaced by one or more menu items from task data 112 to create prompt 310. In some embodiments, the list of menu items in the dynamic input value may be the same as the list of menu item in one or more of the example input values. In other embodiments, the menu items of the dynamic input value are completely distinct from the menu items of the example input values, such that no single menu item appears in both the dynamic input value and in an example input value.

FIG. 4B illustrates an example data flow combining task data 112 and a template query 114 to generate a prompt 310 which is used by a trained large language model 134 to generate a natural-language (NL) query 320, according to at least one embodiment. Combining task data 112 and template query 114 to generate prompt 310 may be performed using function 430, which may be implemented using query prompt generator 132. Query prompt generator 132 may replace the placeholder tokens of template query 114 with a sampling (e.g., a subset) of task data 112. In some embodiments, sampling task data 112 may be performed randomly. In some embodiments, task data 112 may be associated with selection weights and the sampling of task data 112 may be performed based on a probability determined by the selection weights. The selection weights may be assigned to different items of task data 112, e.g., according to the statistics of usage of such items in language conversations. In some embodiments, items that have a higher probability of usage may be given larger weights. In some embodiments, at least some items that have a lower probability of usage may still be given large weights, e.g., to generate a sufficient number of training queries for training conversational MLM 192 to appropriately handle requests for such rare items. Query prompt generator 132 may select template query 114 randomly (or with probabilities determined by the selection weights) from task data repository 110. In another embodiment, each template query 114 of task data repository 110 may be associated with a selection weight, and query prompt generator 132 may select template query 114 with a probability determined using the selection weight.

As further illustrated in FIG. 4B for the example restaurant scenario, prompt 310 may include two example input/output pairings of menu items and an NL query with an example order of one or more of the menu items and one dynamic input/output pairing with a list of menu items populated from (a subset of) task data 112 and an empty output value. Prompt 310 may then be provided to trained large language model 134, with the example input/output pairings providing trained large language model 134 with few-shot examples of the kind of output value to be generated. Trained large language model 134 may then complete the dynamic input/output pairing by generating an output value (e.g., NL query 320). As a result of an extensive amount of data that was used to train trained large language model 134, trained large language model 134 may generate an output that more closely simulates a likely human's response to the same prompt 310. For example, trained large language model 134 may generate an output that includes conversational colloquialisms such as asking for “the twelve-piece” instead of “the twelve-piece chicken bucket.” Having such outputs in training data repository 170 may allow training engine 194 to train conversational MLM 192 to respond appropriately to similar colloquialisms. The generated output value (e.g., NL query 320) may then be stored in training data repository 170.

With a continuing reference to FIG. 3, query generator system 120 may then select the same or a different template query 114 from task data repository 110 and may also select the same or a different task data 112 from task data repository 110. Query generator system 120 may replace the placeholder tokens of the selected template query using the selected task data to generate a new prompt 310. The new prompt 310 may then be provided to trained large language model 134 to generate a new output value (e.g., NL query 320), which may subsequently be stored in training data repository 170 (e.g., as generated NL query 172). This process may continue until a target condition is satisfied, e.g., a certain number of NL queries have been generated, a certain number of task data and/or template queries have been selected, a certain amount of time has elapsed since starting the dataset generation process, or the like.

The above examples are used for the sake of illustration and not limitation. The disclosed techniques have a broad applicability and should not be read as being targeted only to a restaurant ordering environment or a navigation domain. In another embodiment, template query 114, with its associated example input/output pairing(s), and task data 112 may relate to a task of a different domain (e.g., a financial services domain, a health services domain, a retail services domain, or the like). In some embodiments, task data repository 110 may have a plurality of template queries 114, each with one or more associated example input/output pairings and one or more dynamic input/output pairings. The output value generated using trained large language model 134 (e.g., NL query 320) may be tuned by changing the few-shot examples (e.g., static portion 410) of template query 114. To ensure a wide variety of generated NL queries 172, task data repository 110 may include a wide variety of template queries 114. In some embodiments, task data repository 110 may include one or more template queries 114 with no static portion 410 (e.g., zero-shot learning template query) or with one example input/output pairing in static portion 410 (e.g., one-shot learning template query). In some embodiments, an example output value of static portion 410 of a template query 114 may include colloquial phrasing, such as (continuing the restaurant example) ordering a menu item by describing it instead of calling it explicitly by name. In another embodiment, an example output value may include ordering a menu item that is not included in the example input value (e.g., an “off-menu” item). In another embodiment, an example output value may include an order requesting multiple menu items (e.g., “ . . . two burgers, a hot dog, and a salad”) and/or an order requesting a menu item with modifications (e.g., “ . . . a cheeseburger without cheese or ketchup”).

With a continuing reference to FIG. 3, in some embodiments, query prompt generator 132 may generate a target 330 in addition to prompt 310. In some embodiments, each input of the input/output pairings of template query 114 may include a condition. The condition may relate to a sub-task of the domain-specific conversational task to be performed by task-oriented dialogue system 180. The condition may be based on one or more tokens of the corresponding input value. The input of the dynamic input/output pairing may also have a condition, with the condition value based on one or more of the selected task data 112. For example, in the above-mentioned restaurant scenario, an example input/output pairing of template query 114 may include a list of menu items, a condition related to one of the menu items, and a NL query ordering the menu item included in the condition. The condition may have a label and a value. For example, a condition in a template query 114 in the restaurant example may have “Directive:” as a label and “How would you order the hamburger?” as a value. By including a condition in the example input/output pairing(s) of template query 114, the variability of generated NL queries 172 may be restricted. In some embodiments, when the input/output pairings of template query 114 contain conditions, the value of task data 112 that is included in the condition may be selected using query prompt generator 132 as target 330. In some embodiments, conditions may be added to input/output pairings of template query 114 or may be added to prompt 310 before prompt 310 is provided to trained large language model 134.

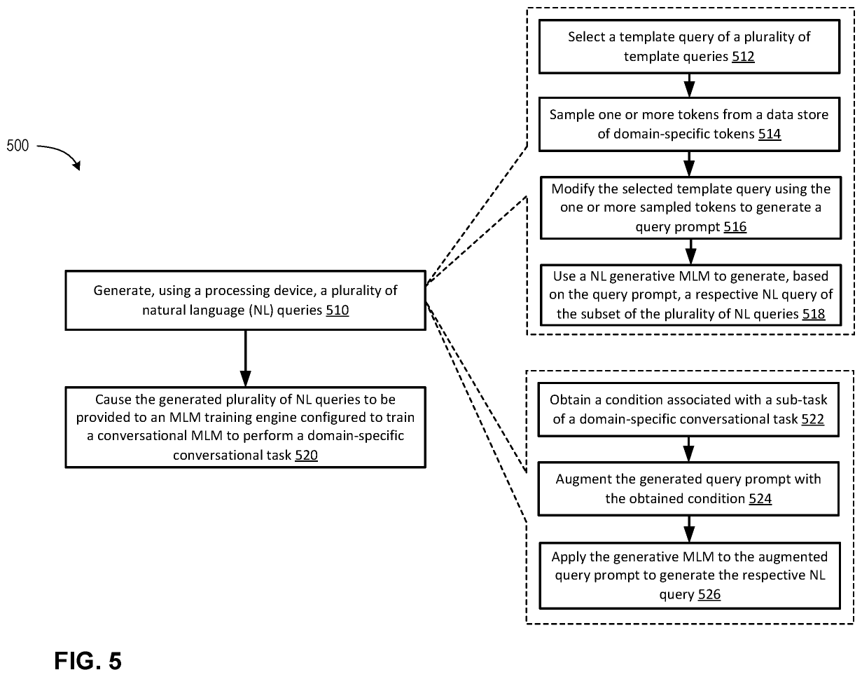

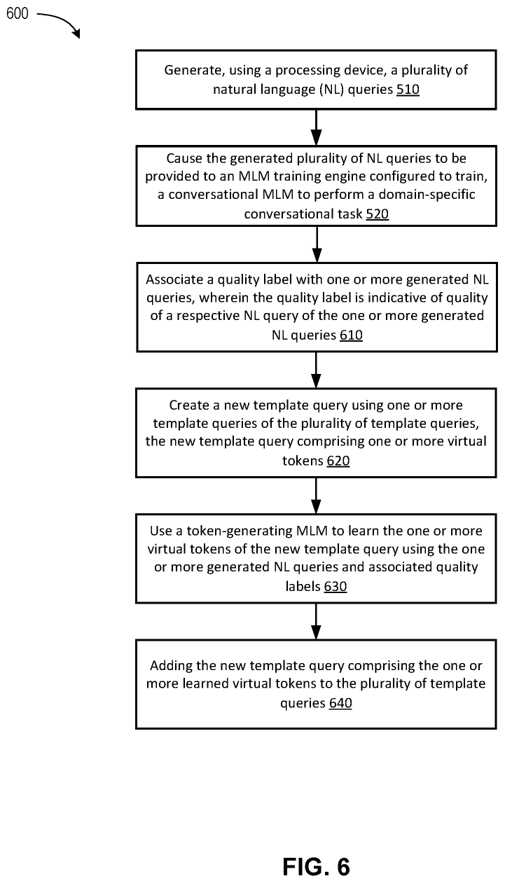

FIG. 5 is a flow diagram of an example method 500 of using task-specific data, template queries, and a trained large language model for generating training data, according to at least one embodiment. FIG. 6 is a flow diagram of an example method 600 of generating a template query using a machine-learning model with learned virtual tokens, according to at least one embodiment. Methods 500 and 600 may be performed using one or more processing units (e.g., CPUs, GPUs, accelerators, PPUs, DPUs, etc.), which may include (or communicate with) one or more memory devices. In at least one embodiment, methods 500 and 600 may be performed using processing units of query generator system 120 and/or task-oriented dialogue system 180. In at least one embodiment, processing units performing any of methods 500 and/or 600 may be executing instructions stored on a non-transient computer-readable storage media. In at least one embodiment, any of methods 500 and/or 600 may be performed using multiple processing threads (e.g., CPU threads and/or GPU threads), individual threads executing one or more individual functions, routines, subroutines, or operations of the method. In at least one embodiment, processing threads implementing any of methods 500 and/or 600 may be synchronized (e.g., using semaphores, critical sections, and/or other thread synchronization mechanisms). Alternatively, processing threads implementing any of methods 500 and/or 600 may be executed asynchronously with respect to each other. Various operations of any of methods 500 and/or 600 may be performed in a different order compared with the order shown in FIG. 5 and/or FIG. 6. Some operations of any of methods 500 and/or 600 may be performed concurrently with other operations. In at least one embodiment, one or more operations shown in FIG. 5 and/or FIG. 6 may not always be performed. Methods 500 and 600 may involve data (e.g., domain-specific tokens, task data) related to one or more domains where task-oriented dialogue systems may be used. Methods 500 and 600 may also use template queries tailored to the domain(s) in which the task-oriented dialogue system may be used.

FIG. 5 is a flow diagram of an example method 500 of using task-specific data, template queries, and a trained large language model for generating training data, according to some embodiments of the present disclosure. At block 510, processing units executing method 500 may generate a plurality of natural language (NL) queries. The generated plurality of NL queries may approximate the NL queries that the task-oriented dialogue system may receive from human users. As indicated with the top callout portion of FIG. 5, generating the plurality of NL queries may include a number of processing operations. More specifically, as indicated by block 512, generating the plurality of NL queries may include selecting a template query (e.g., template query 114 of FIG. 1) of a plurality of template queries (e.g., template queries stored in task data repository 110 of FIG. 1). As indicated by block 514, generating the plurality of NL queries may include sampling one or more tokens (e.g., task data 112) from a data store of domain-specific tokens (e.g., task data repository 110 of FIG. 1). The sampling of one or more tokens from the data store of domain-specific tokens may be performed according to the methods described herein at least in relation to function 430 of FIG. 4B above. As indicated by block 516, generating the plurality of NL queries may include modifying the selected template query using the one or more sampled tokens to generate a query prompt (e.g., prompt 310). Modifying the selected template query using the one or more sampled tokens may be performed using query generator system 120 of FIG. 1 and/or FIG. 3. As indicated by block 518, generating the plurality of NL queries may include using a NL generative MLM to generate, based on the query prompt, a respective NL query of the subset of the plurality of NL queries.

In some embodiments, generating the plurality of NL queries may include using a template query that includes a condition, as illustrated with the bottom callout portion of FIG. 5. Specifically, as indicated by block 522, generating the plurality of NL queries may include obtaining a condition associated with a sub-task of a domain-specific conversational task. For example, if the domain-specific conversational task is placing an order at a restaurant, a sub-task may include ordering a particular item at the restaurant. At block 524, generating the plurality of NL queries may include augmenting the generated query prompt with the obtained condition. At block 526, generating the plurality of NL queries may include applying the generative MLM to the augmented query prompt to generate the respective NL query. Method 500 may include, at block 520, causing the generated plurality of NL queries (e.g., generated NL query 172 of FIG. 3) to be provided to an MLM training engine (e.g., training engine 194 of FIG. 3) configured to train a conversational MLM (e.g., conversational MLM 192 of FIG. 3) to perform a domain-specific conversational task.

FIG. 6 is a flow diagram of an example method 600 of generating a template query using a machine-learning model with learned virtual tokens, according to some embodiments of the present disclosure. Method 600 may include, at block 510, generating a plurality of NL queries and, at block 520, causing the generated plurality of NL queries to be provided to an MLM training engine, e.g., as described in conjunction with the respective blocks of method 500. In order to improve the quality of the generated NL queries, method 600 may include, at block 610, associating a quality label with one or more generated NL queries. The quality label may be indicative of quality of a respective NL query of the one or more generated NL queries. At block 620, method 600 may include creating a new template query using one or more template queries of the plurality of template queries. The new template query may include one or more virtual tokens. Method 600 may include, at block 630, using a token-generating MLM to learn the one or more virtual tokens of the new template query using the one or more generated NL queries and associated quality labels. Method 600 may include, at block 640, adding the new template query, including the one or more learned virtual tokens, to the plurality of template queries.

The systems and methods described herein may be used for a variety of purposes, by way of example and without limitation, for performing one or more operations with respect to systems or methods associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, chat bots, digital avatars, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an in-vehicle infotainment system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for generating or presenting virtual reality content, mixed reality content, or augmented reality content, systems for performing conversational AI operations, systems for performing light transport simulation, systems for performing collaborative content creation for 3D assets, systems implemented at least partially using cloud computing resources, and/or other types of systems.

### Inference and Training Logic

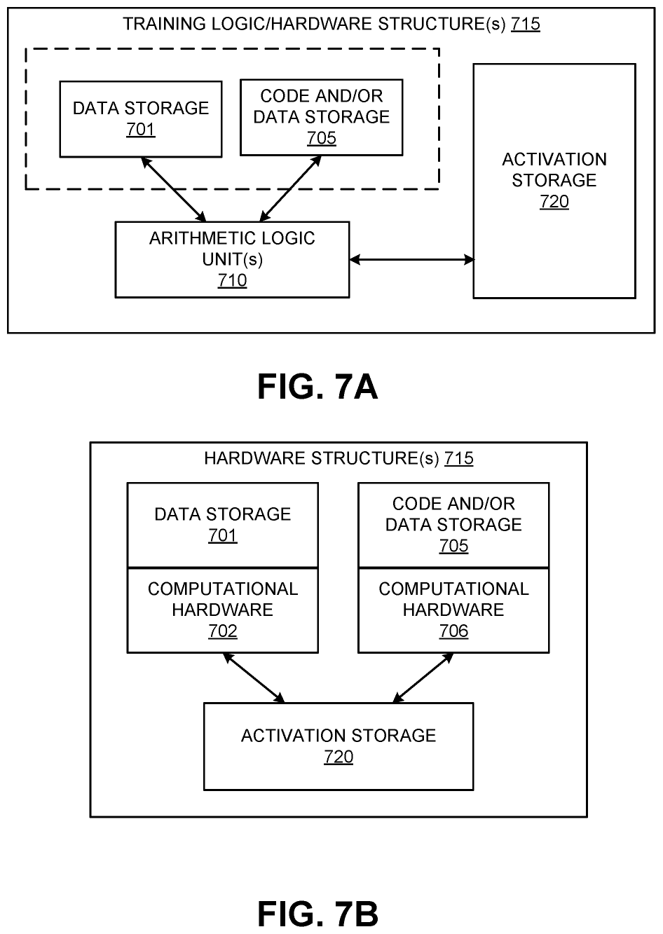

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include (or be coupled to code and/or data storage 701 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include (or be coupled to code and/or data storage 705 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, the result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

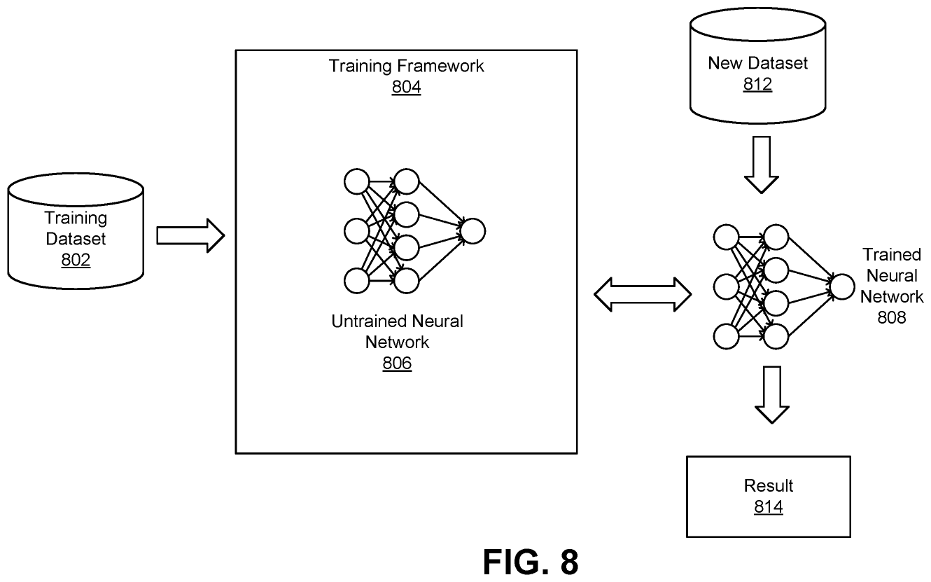

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

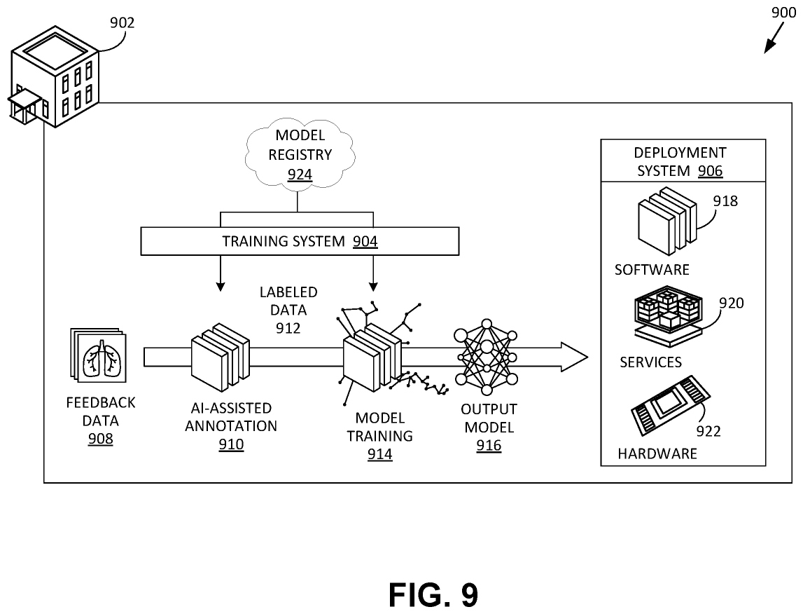

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

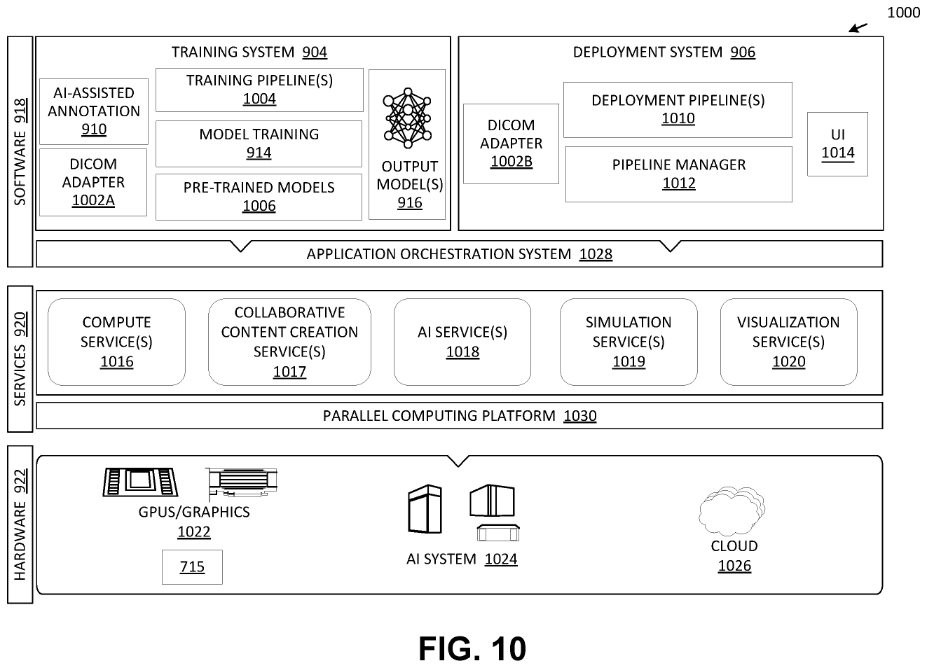

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914 may include data—e.g., AI-assisted annotations 910, labeled data 912, or a combination thereof—that may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inferencing pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public internet service providers (ISPs) that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904 and may be implemented by deployment system 906.

In at least one embodiment, output model(s) 916 and/or pre-trained model(s) 1006 may include any types of machine learning models depending on embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LS™, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of the applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDAR) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA R and/or QUADROR GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC™) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDAR), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
performing one or more conversational tasks in a target domain using a machine learning model (MLM), the MLM trained, at least, by:
generating a plurality of natural language (NL) queries, at least one NL query of the plurality of NL queries generated, at least, by:
selecting a template query from a plurality of template queries;
sampling one or more tokens from a plurality of tokens corresponding to the target domain;
modifying the template query using the one or more tokens to generate a query prompt; and
using a large language model (LLM) to generate, based at least on the query prompt, the at least one NL query of the plurality of NL queries; and
updating one or more parameters of the MLM using the plurality of NL queries.

2. The method of claim 1, wherein the template query comprises:
an example query corresponding to the target domain, and
an NL response to the example query.

3. The method of claim 2, wherein the template query further comprises one or more placeholders, and wherein the modifying the template query comprises replacing the one or more placeholders with the one or more tokens.

4. The method of claim 2, wherein the example query corresponds to an example conversation between a customer and a service provider in at least one of:
a financial services domain,
a food services domain,
a health services domain, or
a retail services domain.

5. The method of claim 1, wherein the sampling the one or more tokens is performed randomly.

6. The method of claim 1, wherein at least one template query of the plurality of template queries is associated with a selection weight, and wherein the template query is selected with a probability determined using the selection weight.

7. The method of claim 1, further comprising:
obtaining a condition associated with a sub-task of the conversational task;
augmenting the query prompt with the obtained condition to generate an augmented query prompt; and
applying the augmented query prompt to the LLM to generate the at least one NL query.

8. The method of claim 7, wherein the one or more tokens includes a plurality of tokens, and the obtaining the condition comprises:
selecting a subset of at least one of the plurality of tokens; and
combining the subset with a condition template associated with the sub-task,
wherein the training the MLM includes using the subset.

9. The method of claim 1, further comprising:
associating a quality label with one or more NL queries, the quality label being indicative of a quality of a respective NL query of the one or more NL queries;
creating a new template query using one or more template queries of the plurality of template queries, the new template query comprising one or more virtual tokens;
using another MLM to learn the one or more virtual tokens of the new template query using the one or more NL queries and associated quality labels; and
adding the new template query comprising the one or more learned virtual tokens to the plurality of template queries.

10. A system comprising:
one or more processing units to:
generate a plurality of natural language (NL) queries, at least, by:
selecting a template query of a plurality of template queries;
sampling one or more tokens from a data store of domain-specific tokens;
modifying the selected template query using the one or more sampled tokens to generate a query prompt; and
using a large language model (LLM) to generate, based at least on the query prompt, a respective NL query of the subset of the plurality of NL queries; and
provided the generated plurality of NL queries to an MLM training engine to cause the MLM training engine to train a MLM to perform a domain-specific conversational task.

11. The system of claim 10, wherein the selected template query comprises:
a domain-specific example query, and
an NL response to the example query.

12. The system of claim 11, wherein the selected template query further comprises one or more placeholders, and wherein to modify the selected template query, the one or more processing units replace the one or more placeholders with the one or more sampled tokens.

13. The system of claim 11, wherein the domain-specific example query corresponds to an example conversation between a customer and a service provider in at least one of:
a financial services domain,
a food services domain,
a health services domain, or
a retail services domain.

14. The system of claim 10, wherein the sampling the one or more tokens is performed randomly.

15. The system of claim 10, wherein one or more individual template queries of the plurality of template queries is associated with a selection weight, and wherein the selected template query is selected with a probability determined using the selection weight.

16. The system of claim 10, wherein the one or more processing units are further to:
obtain a condition associated with a sub-task of the domain-specific conversational task;
augment the generated query prompt with the obtained condition; and
apply the LLM to the augmented query prompt to generate the respective NL query.

17. The system of claim 16, wherein, to obtain the condition associated with the sub-task of the domain-specific conversational task, the one or more processing units are to:
select a subset of at least one of the one or more sampled tokens; and
combine the selected subset with a condition template associated with the sub-task,
wherein the one or more processing units are further to provide the selected subset to the MLM training engine.

18. The system of claim 10, wherein the one or more processing units are further to:
associate a quality label with one or more generated NL queries, the quality label being indicative of quality of a respective NL query of the one or more generated NL queries;
create a new template query using one or more template queries of the plurality of template queries, the new template query comprising one or more virtual tokens;
use a token-generating MLM to learn the one or more virtual tokens of the new template query using the one or more generated NL queries and associated quality labels; and
add the new template query comprising the one or more learned virtual tokens to the plurality of template queries.

19. The system of claim 10, wherein the system is comprised in at least one of:
an in-vehicle infotainment system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, mixed reality content, or augmented reality content;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

20. A processor comprising:
one or more processing units to perform one or more natural language processing tasks using a machine learning model, the machine learning model trained, at least, using natural language queries generated using a large language model (LLM).
